(19) United States
(12) Patent Application Publication
(10) Pub. No.: US 2014/0024260 A1
(43) Pub. Date: Jan. 23, 2014

(54) EMI PROOF AND DUST PROOF CONNECTOR PLUG FOR USE WITH A RECEPTACLE CONNECTOR HAVING TWO RESILIENT PLATES

(71) Applicant: ADVANCED-CONNETEK INC., New Taipei City (TW)

(72) Inventors: Fei-wu DONG, New Taipei City (TW); Wei WAN, New Taipei City (TW); Sheng-Chan LIN, New Taipei City (TW); Shu-lin DUAN, New Taipei City (TW)

(21) Appl. No.: 13/946,831

(22) Filed: Jul. 19, 2013

(30) Foreign Application Priority Data
Jul. 20, 2012 (CN) 201220354120.8

(51) Int. Cl. H01R 13/648

(52) U.S. Cl. CPC H01R 13/648
USPC 439/626

(57) ABSTRACT

A plug connector for use with a receptacle connector having at least two resilient plates has a metal shell having at least two recesses defined in a side face thereof to correspond to and receive the at least two resilient plates of the receptacle connector therein and an insulating housing securely received in the metal shell and having multiple terminals therein.

### FIELD OF THE INVENTION

The invention relates to a plug connector, and more particular, to a plug connector having therein at least two recesses defined in a side face thereof to effectively avoid EMI and prevent contamination to the internal structure of the plug connector.

### BACKGROUND OF THE INVENTION

USB (Universal Serial Bus), a standard serial bus for connecting a computer to a foreign device and also an input/output interface protocol, with the advantage of plug-in and fast transmission speed, is widely used in information products such as personal computers, mobile communication devices and can also be expanded to cameras, digital TVs, video game machines . . . etc..

Following the demands for transmission speed and storing capacity, the transmission speed for USB is up grated from USB 2.0 (High Speed)(Max transmission speed is 480 Mbps to USB 3.0 with the fastest speed (Super Speed) (Max transmission speed is 5 Gbps) in desire to provide a product having a transmission speed 10 times faster than the current transmission speed.

The current USB connector usually has a metal shell and an insulating housing securely received in the metal shell and having therein multiple terminals. The metal shell usually is provided with two holes. The insulating housing is received in the metal shell, and a plurality of terminals is located on the insulating housing.

When the USB plug connector is inserted into a corresponding receptacle connector, due to two resilient plates formed on side a face of the receptacle connector, the two resilient plates extend into the two holes of the metal shell of the connector and subsequently engage with the metal shell to satisfy connection requirements as well as ground.

While in application of the connector, EMI (electromagnetic interference), an electromagnetic phenomenon that is able to affect and eventually reduce the capability of the devices, equipment or system, is another reason to consider when in design of the connector assembly in order to avoid loss of capability due to EMI. However, due to the requirement of the two holes and since there is no sheltering device to prevent influence from EMI, when the plug connector is to connect to the receptacle connector, EMI becomes the biggest concern for function stability. Moreover, the two holes easily trap dust and/or debris of some kind and hence the function of the connector assembly is thus hindered.

As the reason set forth, it is crucial to develop a connector to prevent serious EMI when the information is being transmitted.

### SUMMARY OF THE INVENTION

The primary objective of the present invention is to provide a dust proof and EMI proof plug connector.

In order to accomplish the aforementioned objective, the plug connector constructed in accordance with the present invention comprising a metal shell including multiple side walls and surrounded by the side wall to form a receiving space and an insulating housing securely is received in the receiving space of the metal shell and a plurality of terminals is located on the insulating housing, the characterized in that:

a metal shell with at least two closed recesses defined in one of the side wall thereof to correspond to and receive therein the at least two resilient plates of a receptacle connector;

In still another embodiment, the insulating housing further has a first body and a second body securely connected to the first body.

In a preferred embodiment of the present invention, the at least two recesses are defined by stretching.

In a preferred embodiment of the present invention, the terminals comply with USB (Universal Serial Bus) 2.0 transmission standard.

In a preferred embodiment of the present invention, the terminals comply with USB 3.0 transmission standard.

### BRIEF DESCRIPTION OF THE DRAWINGS

FIG. 1A is a perspective view of showing the structure of the plug connector of the present invention;

FIG. 1B is a perspective view of the plug connector viewed from another aspect;

FIG. 2 is an exploded perspective view of the plug connector of the present invention;

FIG. 3 is still another exploded perspective view of the plug connector of the present invention; and

FIG. 4 is a schematic perspective view of the plug connector of the present invention as well as the receptacle connector.

### DETAILED DESCRIPTION OF THE INVENTION

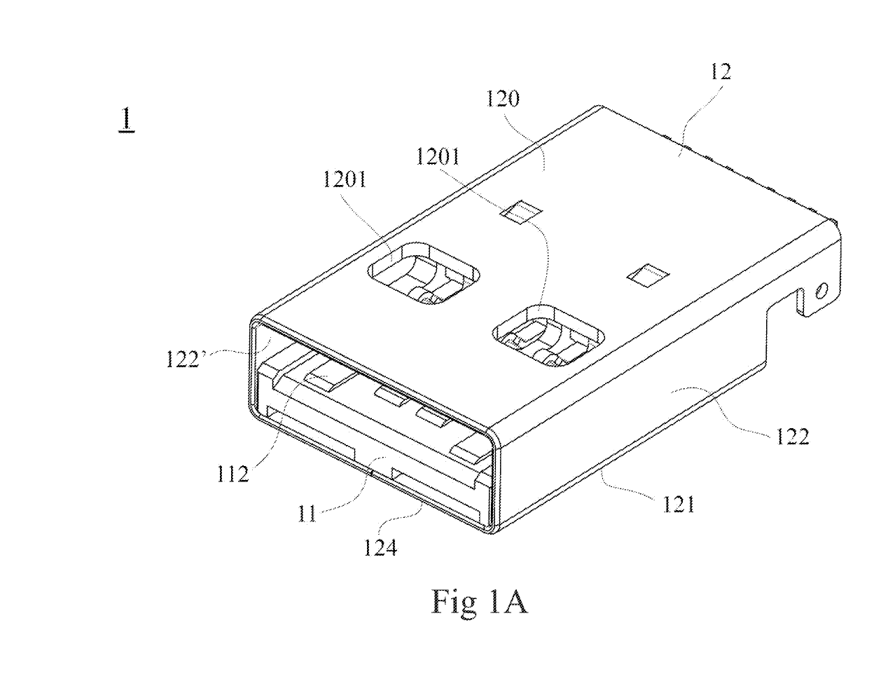

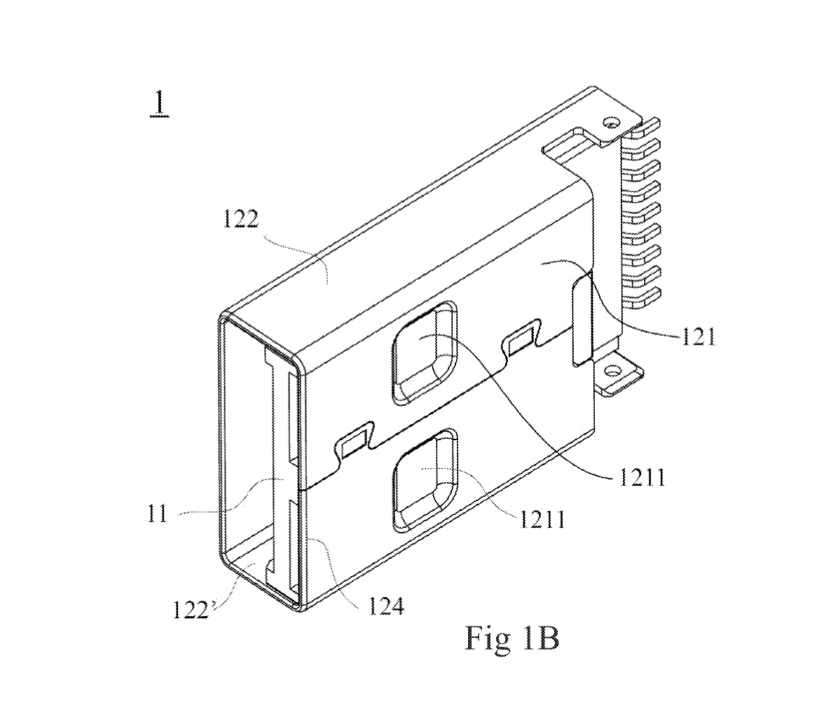

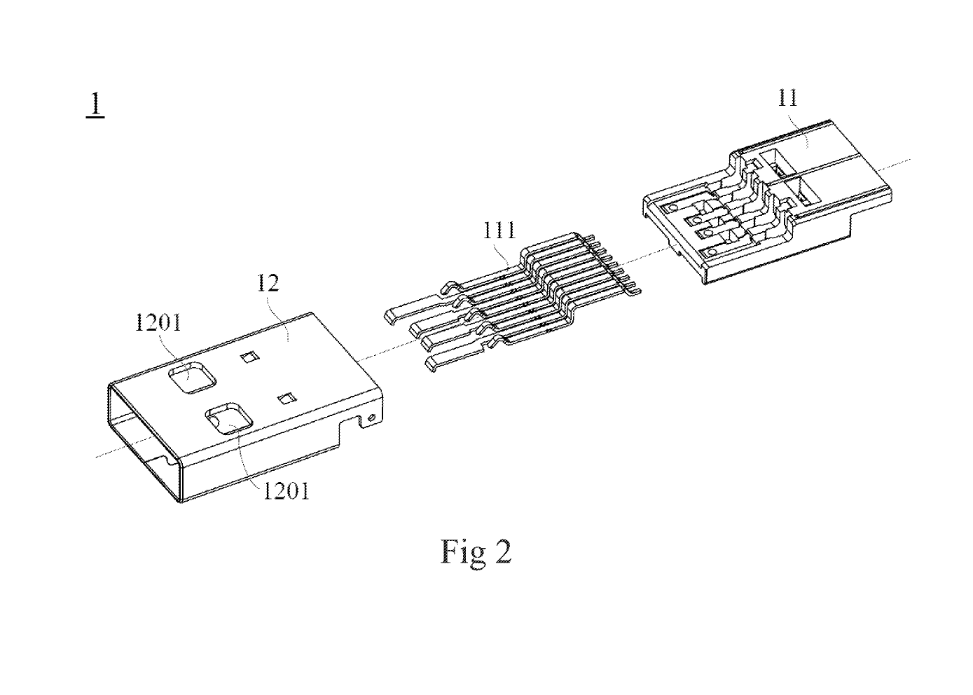

With reference to FIGS. 1A-1B and 2, the plug connector constructed in accordance with the preferred embodiment of the present invention is composed of an insulating housing 11 and a metal shell 12. In this embodiment, the plug connector is a USB plug connector 1. Preferably, the plug connector 1 is a USB 3.0 plug connector.

The metal shell 12 including a plurality of side walls (120, 121, 122 and 122′) and surrounded by the side wall to form a receiving space 124. And the metal shell 12 has at least two recesses 1211 defined in the side wall thereof. The at least two recesses 1211 are defined by stretching. The insulating housing 11 is received in the metal shell 12 and has multiple terminals 111 therein. Preferably, the insulating housing 11 is an integral body. In this embodiment, the insulating housing 11 is made by insert molding to carry the terminals 111 therein. After the terminals 111 are securely received in the insulating housing 11, the insulating housing 11 with the terminals 111 is inserted into the metal shell 12. In this embodiment, the side wall 121 of the metal shell 12 has at least two recesses 1211 (shown in FIG. 1B). For example, the two recesses with geometric configurations are formed. And the two traditional locating portions 1201 are formed or penetrated on the side wall 120 opposite to the side wall 121 (shown in FIG. 1A). Moreover, the recess 1211 of the metal shell 12 is a closed structure. It is emphasized that to compare with the metal shell 12 with holes disclosed in the prior art, the plug connector 1 of the present invention with more intact metal structure provides a well-shielding function.

In addition, the foresaid embodiment of the present invention discloses the locating portions 1201 with traditional holes on the side wall 120 of the metal shell 12 and the recesses 1211 with closed structures on the side wall 121. Alternatively, the recesses 1211 with closed structure can be formed on one of the side wall (120,121, 122 and 122′) of the metal shell 12, and thus the recesses 1211 is not limited to be formed on the side wall 121.

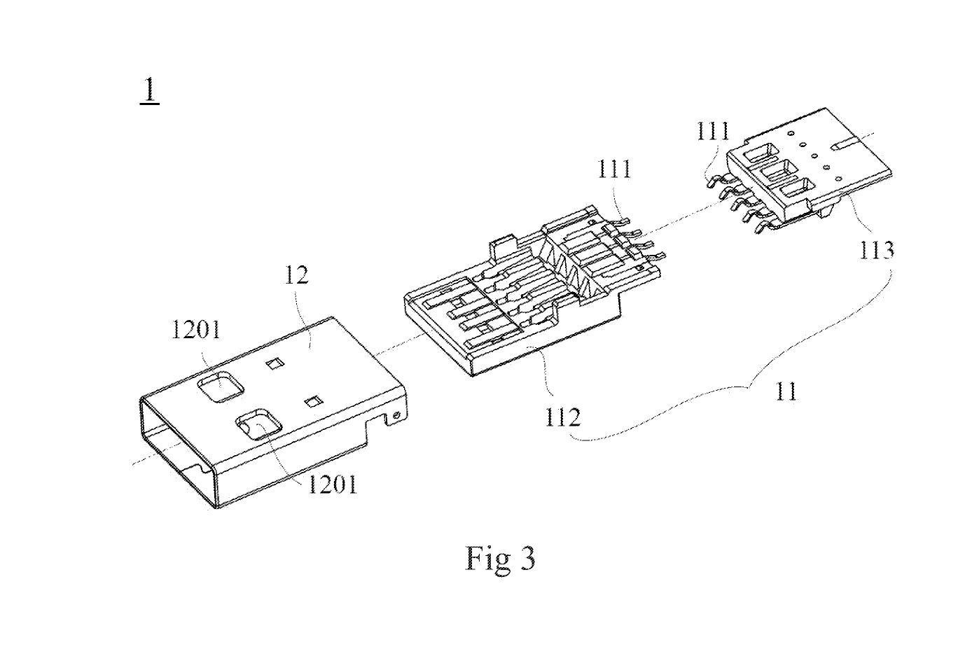

With reference to FIG. 3, it is to be noted that the insulating housing 11 is composed of a first body 112 and a second body 113 to be securely connected to the first body 112. However, the first body 112 and the second body 113 are not and should never be deemed as limitation to the structure of the insulating housing 11. The showing of FIG. 3 is for exemplary purpose only.

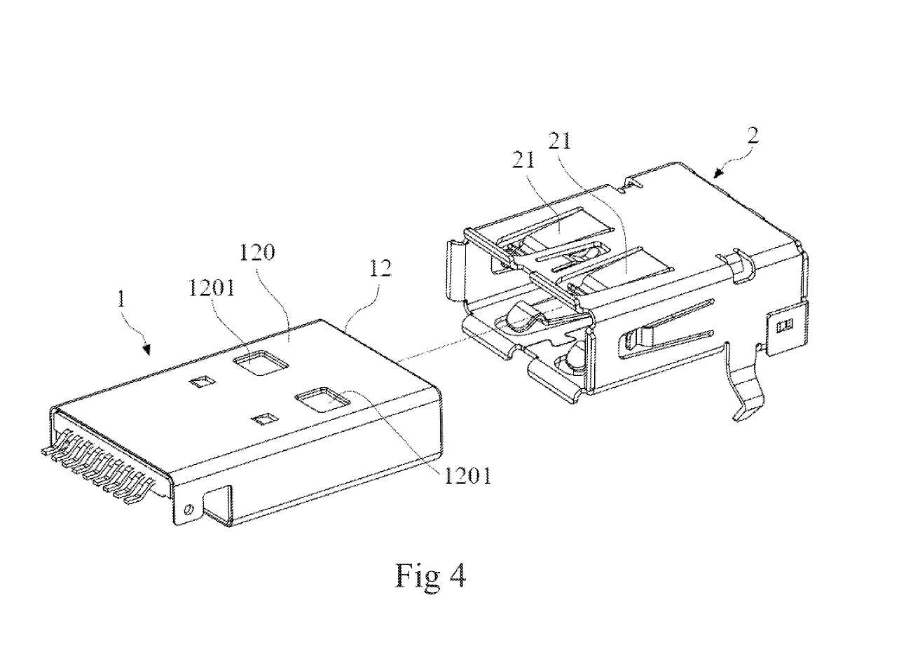

With reference to FIG. 4, from the showing of this embodiment, it is noted that the metal shell 12 has at least two recesses 1211 such that dust or debris of some kind will not fall into the internal structure of the metal shell 12 of the present invention to hinder the function.

In addition, the plug connector 1 of the preferred embodiment of the present invention is used for connecting to a receptacle connector 2. The receptacle connector 2 has at least two resilient plates 21 such that when the plug connector 1 is inserted into the space in the receptacle connector 2, the at least two resilient plates 21 of the receptacle connector 2 are received in the corresponding at least two recesses 1211. After the at least two resilient plates 21 are received in the at least two recesses 1211, the at least two resilient plates 21 engage with side faces defining the at least two recesses 1211 to achieve the purpose of grounding. With the assistance of the at least two recesses 1211, EMI can be effectively prevented from within the plug connector 1 or from ambient of the plug connector 1 of the present invention.

From the description set forth, it is noted that the plug connector of the preferred embodiments of the present invention has the following advantages:
1. The design of recess prevents internal structure of the plug connector from contamination by foreign objects such as dust or debris.
2. The sheltering effect by the recess is able to effectively avoid EMI.

It is to be noted that although the preferred embodiment of the present invention has been described, other modifications, alterations or minor change to the structure should still be within the scope defined in the claims. As those skilled in the art will readily observe that numerous modifications and alterations of the device and method may be made while retaining the teachings of the invention.

What is claimed is:

1. A plug connector comprising a metal shell including multiple side walls and surrounded by the side wall to form a receiving space and an insulating housing securely received in a receiving space of the metal shell and a plurality of terminals is located on the insulating housing, the characterized in that:
the metal shell with at least two recesses defined in one of the side wall thereof to correspond to and receive the at least two resilient plates of a receptacle connector therein.

2. The plug connector as claimed in claim 1, wherein the insulating housing further has a first body and a second body to be securely connected to the first body.

3. The plug connector as claimed in claim 1, wherein the at least two recesses are formed by stretching.

4. The plug connector as claimed in claim 1, wherein the terminals comply with USB 2.0 transmission standard.

5. The plug connector as claimed in claim 1, wherein the terminals comply with USB 3.0 transmission standard.
